(19) United States
(12) Patent Application Publication
(10) Pub. No.: US 2023/0329295 A1
(43) Pub. Date: Oct. 19, 2023

(54) KIND OF PHYCOCYANIN TARO BALL AND PREPARATION METHOD

(71) Applicant: Huzhou University, Huzhou (CN)

(72) Inventors: Zhongshan Zhang, Huzhou (CN); Xinyue Li, Huzhou (CN); Xiaomei Wang, Huzhou (CN); Meng Zhao, Huzhou (CN); Zikang Ding, Huzhou (CN); Bingquan Zhang, Huzhou (CN); Wenzhou Xiang, Huzhou (CN)

(21) Appl. No.: 18/072,044

(22) Filed: Nov. 30, 2022

(30) Foreign Application Priority Data
Apr. 14, 2022 (CN) 202210387727.4

(51) Int. Cl. A23L 19/10; A23L 33/185; A23L 29/256; A23L 29/30

(52) U.S. Cl. CPC A23L 19/10; A23L 33/185; A23L 29/256; A23L 29/30

(57) ABSTRACT

The invention provides a kind of phycocyanin taro ball and preparation method thereof, consisting of the following components in parts by mass: 0.5-2 parts of phycocyanin powder, 45-55 parts of acetic acid-chitosan solution, 50-150 parts of sodium alginate solution, 200-300 parts of taro, 20-30 parts of granulated sugar, 100-200 parts of tapioca starch. The invention adds sodium alginate and chitosan in the preparation process to enhance the flexibility of taro balls, and with the health effects of non-toxic, antioxidant, anti-inflammatory, anti-cancer, hepatoprotective and immunity-enhancing of phycocyanin. Therefore, the phycocyanin taro balls provided by the invention is a kind of food with health care function. The invention not only improves the nutritional value of taro balls, but also increases the market popularity of phycocyanin.

### 1. TECHNICAL FIELD

The invention relates to the field of foodstuffs, in particular to kind of phycocyanin taro ball and preparation method thereof.

### 2. BACKGROUND ART

Taro is a perennial herb with perennial-root property of the family of Araceae, also known as water-arum or Colocasia esculenta and so on. Taro is rich in starch, protein, saponins, vitamins and carotenoids, and with dense, sweet and soft taste, high nutritional value, and no toxic biological components, which can be regarded as the favorite food dishes with edible and medicinal function. As one of the taro products, the taro ball is generally added to cold drinks or milk tea, enabling the taste of the drink richer, and taro is popular among consumers with its taste of sweet, chewy texture, soft and smooth. However, the ordinary taro products with more ordinary taste and color have no health benefits.

Phycocyanin is an uncommon natural green food on the market; in fact, it is the combination of phycocyanin and protein, so the common name is phycocyanin. As a natural pigment extracted from spirulina, phycocyanin is a natural pigment allowed by the FDA, with the property of being water-soluble pigment, non-toxic, pure blue and clear, which can replace the synthetic pigments on the market for food coloring agents as well as additives for cosmetics. However, the scope of the application of phycocyanin as food additives is still very narrow, one of the reasons is that phycocyanin are protein-based pigments, which are not stable enough and easily denatured by heating. Sodium alginate is used as a thickening agent for beverages and dairy products and the application scopes of sodium alginate are limited to the beverages and dairy products generally. There is no report about the preparation of phycocyanin and sodium alginate for use in taro food.

### 3. SUMMARY OF THE INVENTION

To solve the above technical problems in the background, the technical solutions provided by the invention is to disclose a kind of phycocyanin taro ball and preparation method thereof.

The technical solutions are as follows:

A kind of phycocyanin taro ball and preparation method thereof, wherein consists of the following components in parts by mass: 0.5-2 parts of phycocyanin powder, 45-55 parts of acetic acid-chitosan solution, 50-150 parts of sodium alginate solution, 200-300 parts of taro, 20-30 parts of granulated sugar, 100-200 parts of tapioca starch.

Preferably, the kind of phycocyanin taro ball consists of the following components in parts by mass: 1-2 parts of phycocyanin powder, 50 parts of acetic acid-chitosan solution, 50 parts of sodium alginate solution, 200-300 parts of taro, 20-30 parts of granulated sugar, 100 parts of tapioca starch.

The kind of phycocyanin taro ball, wherein the acetic acid-chitosan solution has the mass percentage concentration of 1%.

The kind of phycocyanin taro ball wherein the sodium alginate solution has the mass percentage concentration of 1.5%-2.5%.

The preparation method of a kind of phycocyanin taro ball comprises the following steps:
(1) weighing the phycocyanin powder and adding the phycocyanin powder to ice acetic acid-chitosan solution to be heated and stirred, and dried at low temperature and letting stand for use; dissolving the dried phycocyanin powder coated with chitosan in the sodium alginate solution, taking mature and fresh taro without suffering from disease and insect to be washed and peeled; adding the granulated sugar after being steamed, and mixing with the sodium alginate-phycocyanin solution obtained in step (2) to be repeatedly mashed and ground into a puree;
(2) Taking the mashed taro obtained in step (1) and kneading with adding tapioca starch in small amounts and several times and to obtain dough after being knead well.
(3) Kneading and rolling the dough obtained from step (2) into long strips of uniform thickness, cutting into small rectangular pieces, and putting into boiling water to be cooked until it floats, putting out and putting in cold water to obtain phycocyanin taro balls.

The preparation method of a kind of phycocyanin taro ball, wherein the temperature of the low temperature drying process in step (1) does not exceed 70° C.

Compared to the prior arts, the invention has the following advantages and beneficial effects:
1. The invention provides the phycocyanin taro ball, and the addition of phycocyanin in the preparation process, enriches the color of taro balls with the bright blue of phycocyanin, and has the properties and functions of being non-toxic and antioxidant, anti-inflammatory, anti-cancer, hepatoprotective and immune enhancing. Therefore, compared to the ordinary taro balls products on the market, the phycocyanin taro ball have the effects to be regarded as the health food more than a simple beverages and dessert ingredients.
2. The invention increases the stability of phycocyanin by making the phycocyanin coated with chitosan and low temperature drying, which can protect the active ingredients of phycocyanin from being destroyed.
3. Sodium alginate has a unique advantage in thickening taro balls, making the taro balls smoother after addition, with taste of no stickiness and stiffness compared to ordinary taro balls, achieving better palatability, and preventing the phenomenon of viscosity decline during product sterilization, freezing processing and transportation.
4. The invention combines the above three advantages, with the soft and sweet taste of taro balls, the chewy texture and refreshing taste of sodium alginate, and has the bright color of phycocyanin and health care functions. The taro balls prepared by combining phycocyanin and sodium alginate are significantly better than ordinary taro balls in terms of nutritional value, flavor and taste, and color appearance, and the invention improves the added value of taro and enriches the market application of phycocyanin.

### 4. SPECIFIC EMBODIMENT OF THE INVENTION

To make the purpose, technical solutions and advantages of the embodiments provided by the invention more comprehensible, a further description of the invention is given below in combination with embodiments.

### Embodiment 1

(1) Raw materials preparation: weighing the phycocyanin powder of 2.00 g and adding the phycocyanin powder to 50 ml 1% ice acetic acid-chitosan solution to be heated and stirred, and dried at low temperature and letting stand for use; dissolving the dried phycocyanin powder coated with chitosan in the 50 ml 1.5% sodium alginate solution, taking 300 g mature and fresh taro without suffering from disease and insect to be washed and peeled; adding 20 g granulated sugar after being steamed, and mixing with the sodium alginate-phycocyanin solution obtained in step (2) to be repeatedly mashed and ground into a puree;
(2) Taking the mashed taro obtained in step (1) and kneading with adding 100 g tapioca starch in small amounts and several times and to obtain dough after being knead well.
(3) Kneading and rolling the dough obtained from step (2) into long strips of uniform thickness, cutting into small rectangular pieces, and putting into boiling water to be cooked until it floats, putting out and putting in cold water to obtain phycocyanin taro balls.

### Embodiment 2

(1) Raw materials preparation: weighing the phycocyanin powder of 1.00 g and adding the phycocyanin powder to 50 ml 1% ice acetic acid-chitosan solution to be heated and stirred, and dried at low temperature and letting stand for use; dissolving the dried phycocyanin powder coated with chitosan in the 100 ml 12% sodium alginate solution, taking 250 g mature and fresh taro without suffering from disease and insect to be washed and peeled; adding 25 g granulated sugar after being steamed, and mixing with the sodium alginate-phycocyanin solution obtained in step (2) to be repeatedly mashed and ground into a puree;
(2) Taking the mashed taro obtained in step (1) and kneading with adding 150 g tapioca starch in small amounts and several times and to obtain dough after being knead well.
(3) Kneading and rolling the dough obtained from step (2) into long strips of uniform thickness, cutting into small rectangular pieces, and putting into boiling water to be cooked until it floats, putting out and putting in cold water to obtain phycocyanin taro balls.

### Embodiment 3

(1) Raw materials preparation: weighing the phycocyanin powder of 0.5 g and adding the phycocyanin powder to 50 ml 1% ice acetic acid-chitosan solution to be heated and stirred, and dried at low temperature and letting stand for use; dissolving the dried phycocyanin powder coated with chitosan in the 150 ml 2.5% sodium alginate solution, taking 200 g mature and fresh taro without suffering from disease and insect to be washed and peeled; adding 30 g granulated sugar after being steamed, and mixing with the sodium alginate-phycocyanin solution obtained in step (2) to be repeatedly mashed and ground into a puree;
(2) Taking the mashed taro obtained in step (1) and kneading with adding 200 g tapioca starch in small amounts and several times and to obtain dough after being knead well.
(3) Kneading and rolling the dough obtained from step (2) into long strips of uniform thickness, cutting into small rectangular pieces, and putting into boiling water to be cooked until it floats, putting out and putting in cold water to obtain phycocyanin taro balls.

The comparison between the phycocyanin taro balls provided by the invention and commercially available ordinary taro balls in terms of nutritional value and sensory indexes, and as the results are shown in Table 1, phycocyanin taro balls are superior to commercially available taro balls.

TABLE 1
The Comparison Table of Phycocyanin Taro Balls
and Commercially Available Taro Balls

| | | Commercially Available |
|---|---|---|
| | Phycocyanin Taro Balls | Taro Balls |
| Nutritional Value | Balanced Nutrition | Average Nutritional |
| | High Medicinal Value | Value |
| Appearance | Colorful | Single Color |
| | High Transparency | Very Low Transparency |
| | Finished Product with | Uneven Viscosity and |
| | Smoother Surface | Texture of Surface |
| Smelling & Aroma | Slight Seaweed Smelling | No Special Smelling |
| Viscosity & | Higher Viscosity | Low Viscosity |
| Thickness & | Firm Structure | Loose Structure |
| Texture | | |
| Flavor | Richer Flavor | Chewy Texture |
| | Chewy Texture | Single Tasting Level |
| | Richer Tasting Level | |

The invention and the embodiments thereof are described hereinabove, and this description is not restrictive. The above embodiments are only used to illustrate the principles of the invention, and the actual structure is not limited thereto. In summary, any equivalent modifications or replacements and improvements without departing from the spirit and principles of the invention shall all fall within the protection scope of the invention.

1. A kind of phycocyanin taro ball and preparation method thereof, wherein consists of the following components in parts by mass: 0.5-2 parts of phycocyanin powder, 45-55 parts of acetic acid-chitosan solution, 50-150 parts of sodium alginate solution, 200-300 parts of taro, 20-30 parts of granulated sugar, 100-200 parts of tapioca starch.

2. A kind of phycocyanin taro ball and preparation method thereof according to the claim 1, wherein consists of the following components in parts by mass: 1-2 parts of phycocyanin powder, 50 parts of acetic acid-chitosan solution, 50 parts of sodium alginate solution, 200-300 parts of taro, 20-30 parts of granulated sugar, 100 parts of tapioca starch.

3. A kind of phycocyanin taro ball and preparation method thereof according to the claim 1, wherein the acetic acid-chitosan solution has the mass percentage concentration of 1%.

4. A kind of phycocyanin taro ball and preparation method thereof according to the claim 1, wherein the sodium alginate solution has the mass percentage concentration of 1.5%-2.5%

5. The preparation method of a kind of phycocyanin taro ball according to the claim 1, wherein the preparation method comprises the following steps:
(1) weighing the phycocyanin powder and adding the phycocyanin powder to ice acetic acid-chitosan solution to be heated and stirred, and dried at low temperature and letting stand for use; dissolving the dried phycocyanin powder coated with chitosan in the sodium alginate solution, taking mature and fresh taro without suffering from disease and insect to be washed and peeled; adding the granulated sugar after being steamed, and mixing with the sodium alginate-phycocyanin solution obtained in step (2) to be repeatedly mashed and ground into a puree;
(2) Taking the mashed taro obtained in step (1) and kneading with adding tapioca starch in small amounts and several times and to obtain dough after being knead well.
(3) Kneading and rolling the dough obtained from step (2) into long strips of uniform thickness, cutting into small rectangular pieces, and putting into boiling water to be cooked until it floats, putting out and putting in cold water to obtain phycocyanin taro balls.

6. The preparation method of a kind of phycocyanin taro ball according to the claim 5, wherein the temperature of the low temperature drying process in step (1) does not exceed 70° C.
